(19) United States
(12) Patent Application Publication
(10) Pub. No.: US 2013/0078590 A1
(43) Pub. Date: Mar. 28, 2013

(54) Industrial Furnace with Atmosphere Pressurizing Device

(71) Applicant: CHIN-TAO CHIANG, New Taipei City (TW)

(72) Inventor: CHIN-TAO CHIANG, New Taipei City (TW)

(21) Appl. No.: 13/239,404

(22) Filed: Sep. 22, 2011

(51) Int. Cl. F27B 9/04; F27D 7/06

(52) U.S. Cl. 432/152

(57) ABSTRACT

An industrial furnace comprises a main body, multiple heating sets, multiple heat-distributing plates, and an atmosphere pressurizing device. The main body defines a space therein. The heating sets are provided in the main body and arranged evenly above or below the space. The heat-distributing plates are provided corresponding to the heating sets, each plate being mounted between the space and one of the heating sets, so that the space is located between the heat-distributing plates. The atmosphere pressurizing device is mounted on the main body and provided with a conduit for communicating with the space. Thereby, the atmosphere pressurizing device can supply an inert atmosphere to the space via the conduit. The inert atmosphere will have a pressure greater than that of the gas if sublimated from the graphite so that the heat-distributing plates can be prevented from being damaged after a long time of use.

### TECHNICAL FIELD OF THE INVENTION

The present invention relates to an industrial furnace with an atmosphere pressurizing device, and more particularly to a furnace that can effectively inhibit the sublimation of the graphite plates due to heating.

### DESCRIPTION OF THE PRIOR ART

Conventionally, industrial furnaces employ graphite plates to be placed between the top heater and the bottom heater thereof to allow the objects placed in the passageway between the graphite plates to be heated uniformly. Although this technique can alleviate the problem of uneven heating, there is a drawback to be overcome.

In the heating process, due to the high temperature within the furnace, the graphite plates are liable to have a qualitative change after a long time of use. The graphite will begin to give forth a small amount of gas due to sublimation and thus will be damaged. Thus, there is a need for mitigating the drawback of the conventional furnaces.

In view of the foregoing, based on the long-term experiences of related arts and constant efforts on the test and modification, the applicant has contrive an improved industrial furnace that can effectively inhibit the sublimation of the graphite plates in the furnace to allow the service life of the graphite plates to be prolonged.

### SUMMARY OF THE INVENTION

The primary object of the present invention is to provide an industrial furnace that includes an atmosphere pressurizing device that can supply an inert atmosphere having a pressure greater than that of the gas sublimated from the graphite plates due to heating so that the sublimation of the graphite plates can b inhibited so as to save the energy consumption, reduce the cost of fabrication, increase the working temperature, improve the quality of products, and increase the safety.

To achieve the above purpose, the present invention comprises a main body, multiple heating sets, multiple heat-distributing plates or graphite plates, and an atmosphere pressurizing device. The main body defines a space therein. The heating sets are provided in the main body and arranged evenly above or below the space. The heat-distributing plates are provided corresponding to the heating sets, each plate being mounted between the space and one of the heating sets, so that the space is located between the heat-distributing plates. The atmosphere pressurizing device is mounted on the main body and provided with a conduit for communicating with the space. Thereby, when an object to be heated is fed into the feed port to enter the main body, the heating elements of the heating sets will start to supply heat to the heat-distributing plates, which will in turn uniformly distribute heat energy to the space. At the same time, the atmosphere pressurizing device can supply an inert atmosphere to the space via the conduit. Due to the inert atmosphere having a pressure greater than that that of the gas if sublimated from the graphite plates, the sublimation of graphite plates will be inhibited so that the heat-distributing plates or the graphite plates can be prevented from being damaged after a long time of use.

Other objects, advantages, and novel features of the present invention will become more apparent from the following detailed description when taken in conjunction with the accompanying drawings.

### BRIEF DESCRIPTION OF THE DRAWINGS

FIG. 1 is a cross-sectional view of a preferred embodiment according to the present invention.

FIG. 2 is a schematic view of the preferred embodiment showing a first status of operation.

FIG. 3 is a schematic view of the preferred embodiment showing a second status of operation.

FIG. 4 is a schematic view of the preferred embodiment showing a third status of operation.

### DETAILED DESCRIPTION OF THE PREFERRED EMBODIMENTS

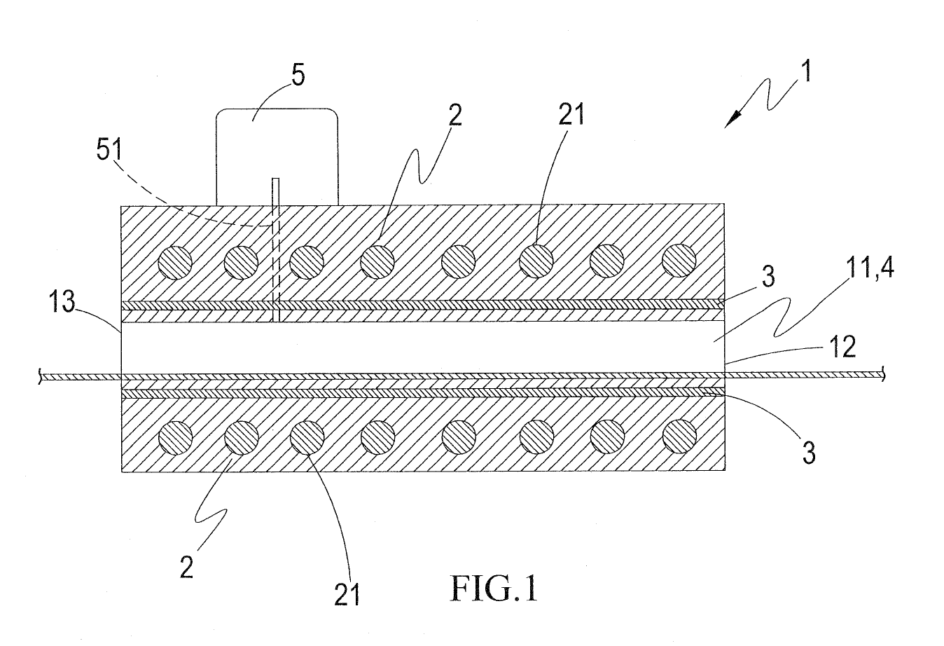

Turning now to FIG. 1, a preferred embodiment of an industrial furnace according to the present invention is illustrated. The furnace comprises a main body 1, multiple heating sets 2, multiple heat-distributing plates 3, and an atmosphere pressurizing device 5. The main body 1 defines a space 11 or a passageway 4 therein and is provided with a feed port 12 and a discharge port 13 at two ends thereof; both of which communicates with the space 4 or the passageway 4, as will be fully described in the following. The heating sets 2 are provided in the main body 1 and arranged evenly above or below the space 11 or the passageway 4. Each heating set 2 includes a plurality of heating elements 21. The heat-distributing plates 3 are provided corresponding to the heating sets 2, each plate being mounted between the space 11 and one of the heating sets 2, so that the space 11 or the passageway 4 is located between the heat-distributing plates 3. The heat-distributing plates 3 are made of graphite. The atmosphere pressurizing device 5 is mounted on the main body 1 and is provided with a conduit 51 for communicating with the space 11 or the passageway 4, so that the device 5 can supply an inert atmosphere or gas to the space 11 or the passageway 4 via the conduit 51 to allow the inert atmosphere or gas to have a pressure greater than that of a gas sublimated from the heat-distributing plates 3 due to heating.

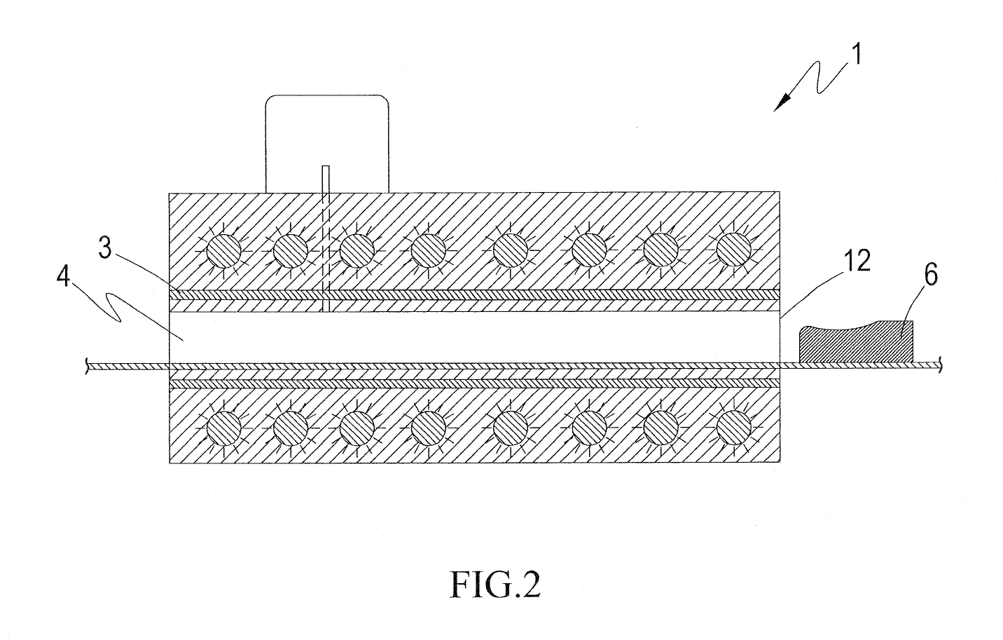

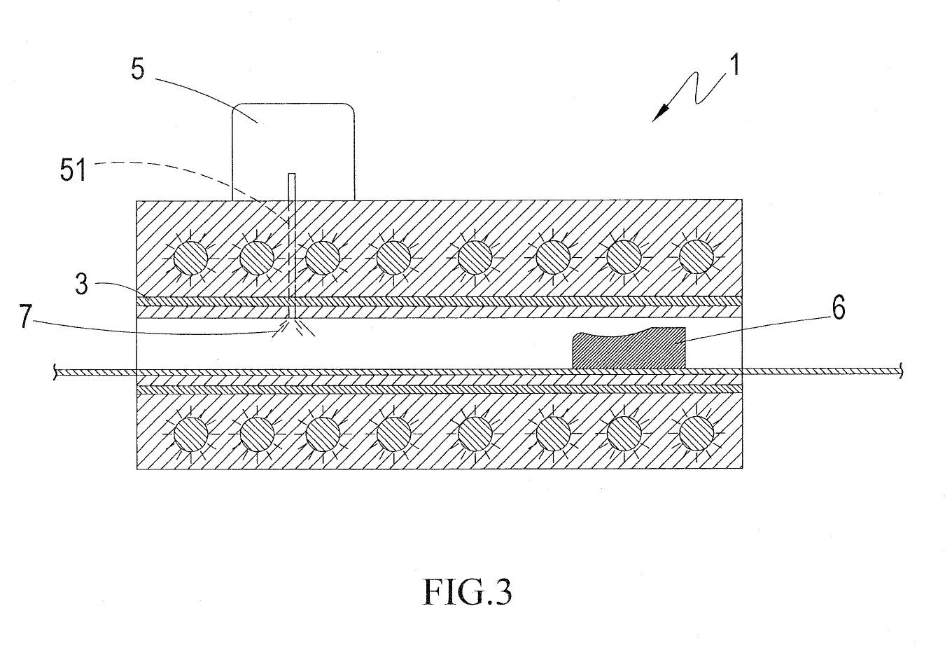

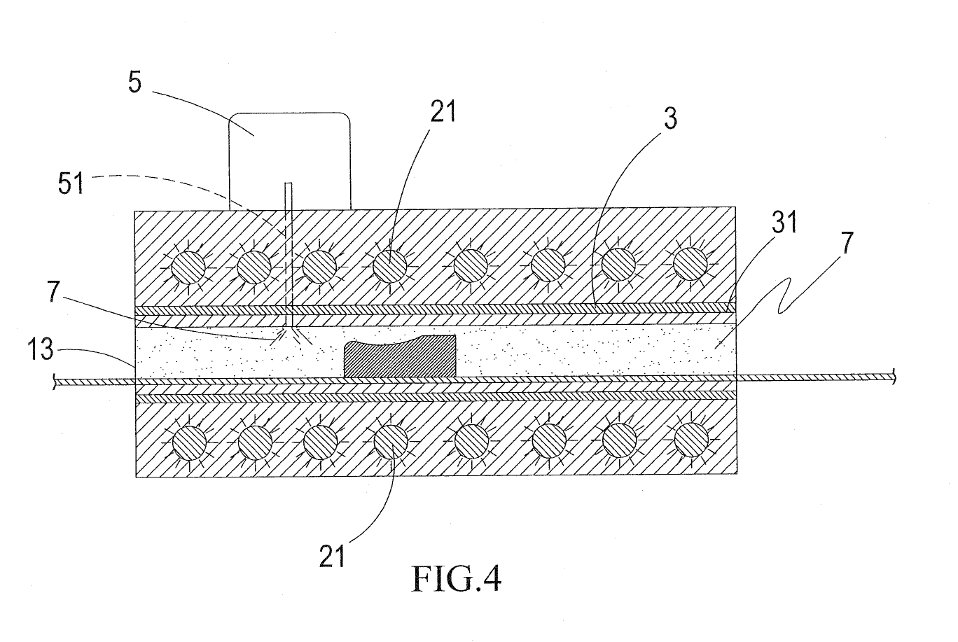

In operation, as shown in FIGS. 2-3, when an object 6 to be heated is prepared to be fed into the feed port 12 to enter the main body 1, the heating elements 21 of the heating sets 2 will start to supply heat to the heat-distributing plates 3, which will in turn uniformly distribute heat energy to the space 11 or the passageway 4 (see FIG. 2). At the same time, the atmosphere pressurizing device 5 can supply the inert atmosphere or gas 7 to the space 11 or the passageway 4 via the conduit 51 (see FIG. 3). Due to the inert atmosphere 7 having a pressure greater than that of the gas 31 if sublimated from the graphite, the sublimation will be inhibited so that the service life of the heat-distributing plate or the graphite plates 3 can be prolonged (see FIG. 4).

Accordingly, the present invention has the following advantages over the prior art:

1. The service life of the heat-distributing plates 3 can be prolonged, so that the cost of replacing the plates can be reduced.

2. Due to the sublimation of the heat-distributing plates 3 being inhibited by the inert atmosphere, the working temperature within the main body 1 can be increased.

3. The quality of heat processing can be improved.

4. The safety can be increased.

5. The energy consumption of heat processing can be reduced.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An industrial furnace comprising:
a main body defining a space therein;
multiple heating sets provided in said main body and arranged evenly above or below said space;
multiple heat-distributing plates corresponding to said heating sets, each said plate being mounted between said space and one of said heating sets, so that said space is located between said heat-distributing plates; and
an atmosphere pressurizing device mounted on said main body and provided with a conduit for communicating with said space.

2. The industrial furnace of claim 1, wherein said atmosphere pressurizing device can supply an inner atmosphere to said space via said conduit to allow the inert atmosphere to have a pressure greater than that of a gas if sublimated from said heat-distributing plates due to heating.

3. The industrial furnace of claim 1, wherein a feed port and a discharge port are respectively provided on two ends of said main body, said feed port and said discharge port being both capable of communicating with said space.

4. The industrial furnace of claim 1, wherein said heating sets each includes a plurality of heating elements.

5. The industrial furnace of claim 1, wherein said heat-distributing plates are graphite plates.
